(19) United States
(12) Patent Application Publication
(10) Pub. No.: US 2026/0164413 A1
(43) Pub. Date: Jun. 11, 2026

(54) RADIO COMMUNICATION NODE AND RADIO COMMUNICATION METHOD

(71) Applicant: NTT DOCOMO, INC., Tokyo (JP)

(72) Inventors: Daisuke Kurita, Tokyo (JP); Hiroki Harada, Tokyo (JP); Weiqi Sun, Beijing (CN); Jing Wang, Beijing (CN); Lan Chen, Beijing (CN)

(73) Assignee: NTT DOCOMO, INC., Tokyo (JP)

(21) Appl. No.: 18/710,396

(22) PCT Filed: Nov. 17, 2022
(86) PCT No.: PCT/JP2022/042762

§ 371 Date: May 15, 2024

(30) Foreign Application Priority Data
Nov. 17, 2021 (JP) 2021-187219

(51) Int. Cl. H04W 72/0446; H04L 5/00

(52) U.S. Cl. CPC H04W 72/0446; H04L 5/0078

(57) ABSTRACT

A radio communication node determines a transmission timing of at least one of a downlink and an uplink, and transmits a control element of a medium access control layer including information on a slot to which the transmission timing determined is applied to the lower node.

### TECHNICAL FIELD

The present invention relates to a radio communication node and a radio communication method for configuring radio access and radio backhaul.

### BACKGROUND ART

3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

For example, in a radio access network (RAN) of NR, an Integrated Access and Backhaul (IAB) is defined in which radio access to a terminal (User Equipment, UE) and radio backhaul between radio communication nodes such as a radio base station (gNB) are integrated (see Non-Patent Literature 1).

In IAB, an IAB node has a Mobile Termination (MT) function for connecting to a parent node (which may be called an IAB donor) and a Distributed Unit (DU) function for connecting to a child node or UE.

In addition, in 3GPP Release 17, 7 cases are specified regarding transmission timing (Timing mode) adjustment (alignment) between a parent node and an IAB node. For example, the timing adjustment of downlink (DL) transmission between an IAB node and an IAB donor (Case #1), the timing adjustment of DL and uplink (UL) transmission within an IAB node (Case #2), and the timing adjustment of DL and uplink (UL) reception within an IAB node (Case #3) are discussed.

In addition, a combination of the timing adjustment of DL transmission in Case 190 1 and the timing adjustment of UL transmission in Case #2 (Case #6), and a combination of the timing adjustment of DL transmission in Case #1 and the timing adjustment of UL reception in Case #3 (Case #7) are discussed.

### CITATION LIST

### Non-Patent Literature

Non-Patent Literature 1

3GPP TS 38.213V 16.7.0, 3rd Generation Partnership Project; Technical Specification Group Radio Access Network; NR; Physical layer procedures for control (Release 16), 3GPP, September 2021

### SUMMARY OF INVENTION

The parent node is considered to use the control element (MAC CE) of the medium access control layer to notify the IAB node of the transmission timing (Timing mode) to be applied.

However, it is not easy to appropriately notify the plurality of Timing modes using the MAC CE.

Therefore, the following disclosure has been made in view of such a situation, and an object of the present disclosure is to provide a radio communication node and a radio communication method capable of appropriately notifying the plurality of Timing modes using the MAC CE.

An aspect of the present disclosure is a radio communication node (For example, radio communication node 100) provided with a control unit (control unit 190) that determines a transmission timing of at least one of a downlink and an uplink, and a transmission unit (lower node connection unit 180) that transmits a control element of a medium access control layer including information on a slot to which the transmission timing determined is applied to the lower node.

An aspect of the present disclosure is a radio communication method comprising a step of determining a transmission timing of at least one of a downlink and an uplink, and transmitting a control element of a medium access control layer including information on a slot to which the transmission timing determined is applied to the lower node.

### BRIEF DESCRIPTION OF DRAWINGS

FIG. 1 is an overall schematic diagram of a the radio communication system 10.

FIG. 2 is a functional block diagram of a radio communication node 50

FIG. 3 is a functional block diagram of a radio communication node 100 and a radio communication node 150.

FIG. 4 is a diagram showing an example of a notification sequence of a Timing mode using a MAC CE.

FIG. 5 is a diagram showing a configuration example of a MAC CE according to Example 1.

FIG. 6 is a diagram showing a configuration example of a MAC CE according to Example 1 (option 2).

FIG. 7 is a diagram showing a configuration example of the MAC CE according to Example 1 (option 3).

FIG. 8 is a diagram showing a configuration example (part 1) of the MAC CE according to Example 2 (option 1).

FIG. 9 is a diagram showing a configuration example (part 1) of the MAC CE according to Example 2 (option 2).

FIG. 10 is a diagram showing a configuration example (part 1) of a MAC CE according to Example 2 (option 3).

FIG. 11 is a diagram showing a configuration example (part 2) of a MAC CE according to Example 2 (option 1).

FIG. 12 is a diagram showing a configuration example (part 2) of a MAC CE according to Example 2 (option 2).

FIG. 13 is a diagram showing configuration example (part 2) of a MAC CE according to an operation example 2 (option 3).

FIG. 14 is an example of the hardware configuration of a radio communication node 50, a radio communication node 100, a radio communication node 150, and a UE200.

FIG. 15 is a configuration example of a vehicle 2001.

### MODES FOR CARRYING OUT THE INVENTION

Embodiments will be explained below with reference to the accompanying drawings. Note that the same or similar reference numerals have been attached to the same functions and configurations, and the description thereof is omitted as appropriate.

### (1) Overall Schematic Configuration of the Radio Communication System

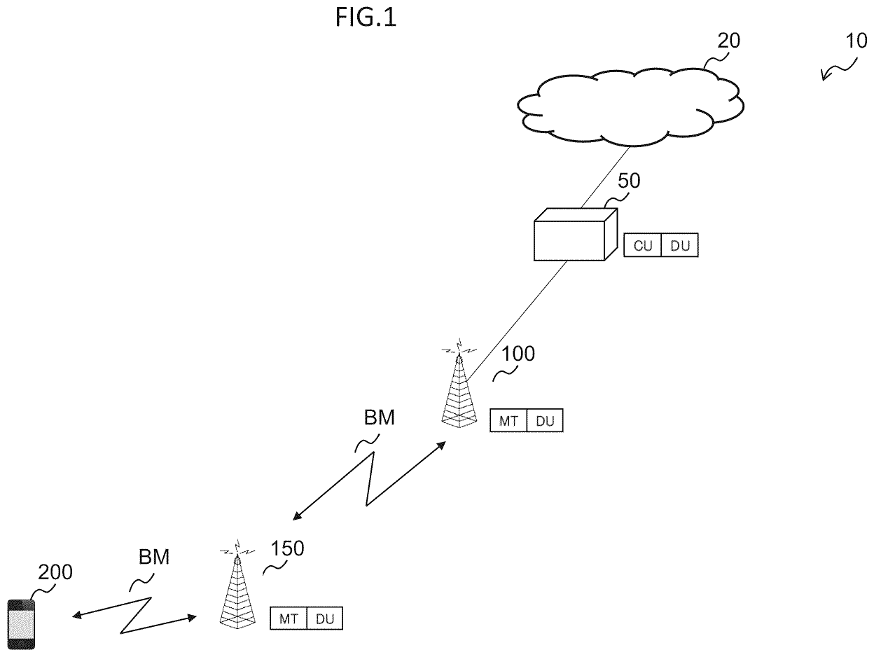

FIG. 1 is an overall schematic configuration diagram of a radio communication system 10 according to the present embodiment. The radio communication system 10 is a radio communication system according to 5G New Radio (NR) and is composed of a plurality of radio communication nodes and terminals. the radio communication system 10 may be a radio communication system according to a system called Beyond 5G, 5G Evolution or 6G.

Specifically, the radio communication system 10 includes a Next Generation-Radio Access Network 20 (hereinafter referred to as the NG-RAN20), a radio communication node 50, a radio communication node 100, a radio communication node 150 and a terminal 200 (UE 200, User Equipment).

The radio communication node 50, the radio communication node 100, and the radio communication node 150 can configure the radio access (access link) with the UE200 and the radio backhaul (backhaul link) between the radio communication nodes via the cell. For example, a backhaul (transmission path) by the radio link may be configured between the radio communication node 50 and the radio communication node 100 or between the radio communication node 100 and the radio communication node 150.

In this manner, a configuration in which the radio access to the UE200 and the radio backhaul between the radio communication nodes are integrated is called Integrated Access and Backhaul (IAB).

The IAB reuses existing functions and interfaces defined for radio access. In particular, Mobile-Termination (MT), gNB-DU (Distributed Unit), gNB-CU (Central Unit), User Plane Function (UPF), Access and Mobility Management Function (AMF) and Session Management Function (SMF), and corresponding interfaces, such as NR Uu (between MT and gNB/DU), F1, NG, X2 and N4, may be used as baselines.

The radio communication node 100 is connected to the NG-RAN20 and the core network (Next Generation Core (NGC) or 5GC) via a wired transmission line, such as a fiber transport. NG-RAN and NGC may be included and simply referred to as “network.”

In this embodiment, the radio communication node 50 constitutes an IAB donor in the IAB, and the radio communication node 100 may constitute a parent node in the IAB. The radio communication node 150 may constitute an IAB node in the IAB.

The IAB donor (which may be a parent node) may be referred to as an upper node in relation to the IAB node.

In addition, the IAB donor may be referred to as a parent node or vice versa. The IAB donor may also have a CU and the parent node may be used simply as a name in relation to the IAB node (or child node) and may not have a CU. The IAB node may be referred to as a lower node in relation to the IAB donor (parent node). The child node may also include UE200.

A radio link (Backhaul link) is configured between the IAB donor (or parent node) and the IAB node.

Specifically, a radio link called Link parent may be configured. A backhaul link is configured between the IAB node and the child node. Specifically, a radio link called Link child may be configured.

The Link parent may consist of a DL Parent BH in the down direction and a UL Parent BH in the up direction. The Link_child may consist of a DL Child BH in the down direction and a UL Child BH in the up direction.

The IAB node (which may include a parent node) has a Mobile Termination (IAB-MT) function for connecting to the IAB donor (or parent node) and a Distributed Unit (IAB-DU) function for connecting to the child node (or UE200). The child node also has MT and DU. The IAB donor has Central Unit (CU) and DU.

In terms of DU, downlink (DL), uplink (UL) and flexible time-resource (D/U/F) can be classified as Hard, Soft or Not Available (H/S/NA) type of radio resources utilized by DU. Available or not available is also specified in Soft(S).

Flexible time-resource (F) is a radio resource (time resource and/or frequency resource) available to either DL or UL. “Hard” is a radio resource always available for a DU child link where the corresponding time resource is connected to a child node or UE, and “Soft” is a radio resource (DU resource) where the availability of the corresponding time resource for a DU child link is explicitly or implicitly controlled by the IAB donor (or parent node).

Furthermore, in the case of Soft(S), the radio resource to be notified can be determined based on whether it is IA or INA.

“IA” means that the DU resource is explicitly or implicitly indicated as available. “INA” also means that the DU resource is explicitly or implicitly indicated as unavailable.

In this embodiment, the radio access and radio backhaul can be either half-duplex or full-duplex. Further, time division multiplexing (TDM), space division multiplexing (SDM), and frequency division multiplexing (FDM) can be used as multiplexing systems.

When IAB nodes operate with half-duplex communication, DL Parent BH becomes the receiving (RX) side, UL Parent BH becomes the transmitting (TX) side, DL Child BH becomes the transmitting (TX) side, and UL Child BH becomes the receiving (RX) side. In the case of Time Division Duplex (TDD), the configuration pattern of DL/UL in IAB nodes is not limited to DL-F-UL only, and configuration patterns such as radio backhaul (BH) only and UL-F-DL may be applied. In this embodiment, simultaneous operation of DU and MT of IAB nodes is realized using SIM/FDM.

By controlling radio signals transmitted from a plurality of antenna elements, the radio communication system 10 can support Massive MIMO to generate a more directional antenna beam BM, Carrier Aggregation (CA) to bundle a plurality of component carriers (CCs), and Dual Connectivity (DC) to simultaneously communicate between a UE and each of a plurality of NG-RAN Nodes.

In the radio communication system 10, IAB can also support Dual Connectivity (DC) scenarios, for example, Intra-band DC and Intra-Carrier DC.

An Intra-band DC is a DC within a specific frequency band (band), and multiple component carriers (CCs) may be used. An Intra-Carrier DC is a DC within a band for one CC. An Intra-band DC may include an Intra-Carrier DC.

The radio communication node 150 (IAB node) may be connected to two radio communication nodes 100 to perform a DC. In this case, one radio communication node 100 may constitute a master cell group (MCG) and the other radio communication node 100 may constitute a secondary cell group (SCG).

### (2) Function Block Configuration of Radio Communication System

Next, a function block configuration of the radio communication system 10 will be described. Specifically, a function block configuration of the radio communication node 50, the radio communication node 100, and the radio communication node 150 will be described.

### (2.1) Radio Communication Node 50

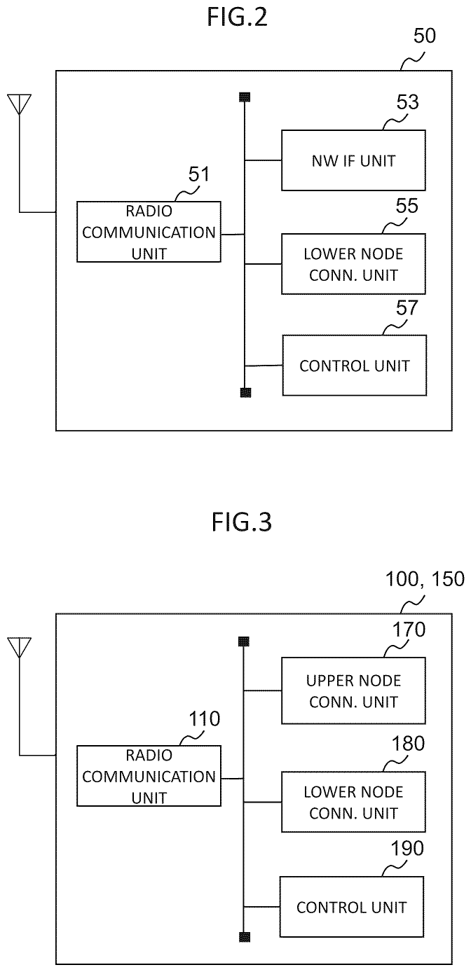

FIG. 2 is a functional block diagram of the radio communication node 50 constituting the IAB donor. As shown in FIG. 2, the radio communication node 50 includes a radio communication unit 51, a NW IF unit 53, a lower node connection unit 55, and a control unit 57.

The radio communication unit 51 transmits and receives radio signals in accordance with the NR. By controlling radio (RF) signals transmitted from a plurality of antenna elements, the radio communication unit 51 can cope with Massive MIMO, which generates a beam with higher directivity, and carrier aggregation (CA), which uses a plurality of component carriers (CCs) bundled together. The radio communication unit 51 may or may not cope with DC.

The NW IF unit 53 provides a communication interface for realizing connection with the NGC side or the like. For example, the NW IF unit 53 may include interfaces such as X2, Xn, N2, N3, etc.

The lower node connection unit 55 may provide an interface, etc., that provides a connection to a lower node than the IAB donor. The lower node means a radio communication node located on the end user side (which may be called the downstream side or the downside) than the IAB donor, and may include the radio communication node 100 (the parent node) and the radio communication node 150 (the IAB node).

The radio link in the lower node (parent node) may mean a radio link between the parent node (radio communication node 100) and the IAB node (radio communication node 150) rather than a radio link between the IAB donor (radio communication node 50) and the parent node (radio communication node 100).

The control unit 57 executes control of each function block constituting the radio communication node 50. In particular, in this embodiment, the control unit 57 executes DC and can execute control of DC between the radio communication node 100 constituting the master node (MN) and the radio communication node 100 constituting the secondary node (SN).

In addition, the control unit 57 may control notification of information (beam information) about the antenna beam BM used by the IAB nodes (IAB-MT and IAB-DU). Specifically, the control unit 57 may notify the beam information applied to the parent node and/or the IAB node via the lower node connection unit 55.

In order to receive the PDSCH (Physical Downlink Shared Channel) or PDCCH (Physical Downlink Control Channel) demodulation reference signal (DMRS), the TCI (Transmission Configuration Indication) state is configured in the NR (If not configured, it can be a QCL relationship with the SSB index of recent PRACH (Physical Random Access Channel) transmissions.).

The TCI state may be explicitly configured by a control element (MAC CE) of the radio resource control layer (RRC) or the medium access control layer (MAC). The QCL relationship may include both cases where the TCI state is explicitly configured and cases where the TCI state is not configured. The QCL/TCI state/beam (antenna beam) may be interchanged.

Beam information may include any such information about the QCL/TCI state/beam. In short, it may be an index (SSB index) that identifies an SSB (SS/PBCH Block) that is a block of a synchronization signal/notification channel consisting of an SS (Synchronization Signal) and a PBCH (Physical Broadcast CHannel).

### (2.2) Radio Communication Node 100 and Radio Communication Node 150

FIG. 3 is a functional block diagram of the radio communication node 100 constituting a parent node and the radio communication node 150 constituting an IAB node. The functions of the radio communication node 100 will be mainly described below.

As shown in FIG. 3, the radio communication node 100 includes a radio communication unit 110, an upper node connection unit 170, a lower node connection unit 180, and a control unit 190.

The radio communication unit 110 transmits and receives radio signals in accordance with the NR. By controlling radio (RF) signals transmitted from a plurality of antenna elements, the radio communication unit 110 can cope with Massive MIMO, which generates a beam with higher directivity, carrier aggregation (CA), which uses a plurality of component carriers (CCs) bundled together, and dual connectivity (DC), which simultaneously communicates between a UE and two NG-RAN nodes.

The radio communication unit 110 may also receive beam information about the antenna beam BM. Specifically, the radio communication unit 110 may receive beam information about the antenna beam BM of the DU (first unit) of the lower node (which may include an IAB node).

Here, the IAB-DU is associated with the first unit, but the first unit may be called a downstream unit, a distributed unit, or the like. The IAB-MT is associated with the second unit, which may be called by a different name such as an upstream unit or a terminal termination unit.

The upper node connection unit 170 provides an interface for realizing connection with a node higher than the parent node. The upper node refers to a radio communication node located on the network, specifically, the core network side (which may be called the upstream side or the upside) than the parent node.

In the case of the IAB node (radio communication node 150), the upper node connection unit 170 provides an interface for realizing connection with a node higher than the IAB node. In the case of the IAB node, the upper node refers to a radio communication node located on the network, more specifically, the core network side (which may be called the upstream side or the upside) than the IAB node.

Specifically, the upper node connection unit 170 provides the function of Mobile Termination (MT). That is, the upper node connection unit 170 may be used for connection with the upper node in this embodiment.

The upper node connection unit 170 may also transmit to the parent node a control element (MAC CE) of the medium access control layer (MAC) indicating the recommended antenna beam (which may be referred to as the recommended beam) to be used. In this embodiment, the upper node connection unit 170 may comprise a transmission unit.

The recommended antenna beam may be applied to at least one of a plurality of bandwidth portions (BWP) or a plurality of serving cells. The serving cell may be an IAB-DU serving cell or an IAB-MT serving cell.

The Bandwidth Part (bwp) Specifies the Frequency direction and may be read as a frequency domain, a frequency domain, a resource block, a resource block group, a subcarrier, a subchannel, a common frequency resource, and the like.

The lower node connection unit 180 provides an interface for realizing connection with a node lower than the parent node. The lower node means a radio communication node located on the end user side (may be called a downstream side or a downside) than the IAB node.

Specifically, the lower node connection unit 180 provides the function of a distributed unit (DU). That is, in this embodiment, the lower node connection unit 180 is used for connection with an IAB node or a child node (which may be a UE 200) constituting the lower node.

The lower node connection unit 180 can transmit to the lower node a control element (MAC CE) of the medium access control layer containing information on the slot to which the transmission timing (Timing mode) determined by the control unit 190 is applied. In this embodiment, the lower node connection unit 180 constitutes transmission unit.

In particular, in this embodiment, the lower node connection unit 180 may transmit the MAC CE when adjustment of the transmission timing of the DL between the IAB node and the IAB donor (Case #1), a combination of adjustment of the transmission timing of the DL in Case #1 and the transmission timing of the UL in Case #2 (Case #6), and a combination of adjustment of the transmission timing of the DL in Case #1 and the reception timing of the UL in Case #3 (Case #7) are applied as the Timing mode.

The MAC CE may include a Timing mode associated with the slot to which the Timing mode is applied. That is, the MAC CE may include information indicating which Timing mode (For example, Case #1, Case #6 or Case #7) is applied in the slot.

The MAC CE may also include information on the cells formed by the radio communication nodes (higher nodes).

Specifically, the MAC CE may include identification information on the serving cells of the IAB-MT. In addition, the MAC CE may include identification information on the Timing Advance Group (TAG).

Alternatively, the MAC CE may include information on recommended antenna beams recommended for use. Specifically, it may include information that links the recommended antenna beams with slots to which the recommended antenna beams are applied. More specifically, information on the recommended antenna beams may be linked for each of the aforementioned slots, or information on the recommended antenna beams may be linked in units of a plurality of slots.

The control unit 190 executes control of each function block constituting the radio communication node 150. In particular, in this embodiment, the control unit 190 can execute control of the antenna beam BM of the IAB node (child node).

Specifically, the control unit 190 may hold beam information about the antenna beam BM of the IAB-DU. control unit 190 may hold the beam information received from the CU or the like via the upper node connection unit 170.

The control unit 190 may also recognize the beam information related to the second unit of the lower node (IAB node), that is, the antenna beam BM of the IAB-MT, by the operation specified in the 3GPP TS 38.213.

The control unit 190 may retain the beam information related to the antenna beam BM of the IAB-DU and the beam information related to the antenna beam BM of the IAB-MT.

The control unit 190 can control the transmission of the antenna beam BM. Specifically, the control unit 190 may configure the antenna beam BM to be used by the IAB-DU based on the beam information received from the upper node such as the parent node.

The antenna beam BM to be used by the IAB-DU may be different from the antenna beam BM to be used by the IAB-MT, or may overlap in part or in whole.

The control unit 190 may configure the antenna beam BM to be used by the IAB-DU depending on the resource type applied to the IAB-DU (such as D/U/F and/or H/S/NA) and the channel assigned to the IAB-DU or IAB-MT.

In the case of the IAB node (radio communication node 150), the control unit 190 may configure the antenna beam BM to be used by the IAB-MT of its own node based on the beam information received from the parent node (radio communication node 100).

In this case, the antenna beam BM used by the IAB-MT may be different from the antenna beam BM used by the IAB-DU, or may overlap in part or in whole.

The control unit 190 may also determine the transmission timing (Timing mode) of at least one of DL and UL. For example, the control unit 190 may determine the Timing mode of Case #1, Case #6, or Case #7. However, a Timing mode other than the case may be determined.

### (3) Operation of Radio Communication System

Next, the operation of the radio communication system 10 will be described. Specifically, the operation related to the control of the Timing mode will be described.

### (3.1) Operation Outline

In 3GPP Release-17, regarding simultaneous transmission and reception of IAB-MT and IAB-DU, it is considered that the parent node (IAB donor) notifies the IAB node of the Timing mode (Case 190 1, Case #6, or Case #7) on a slot-by-slot basis using MAC CE.

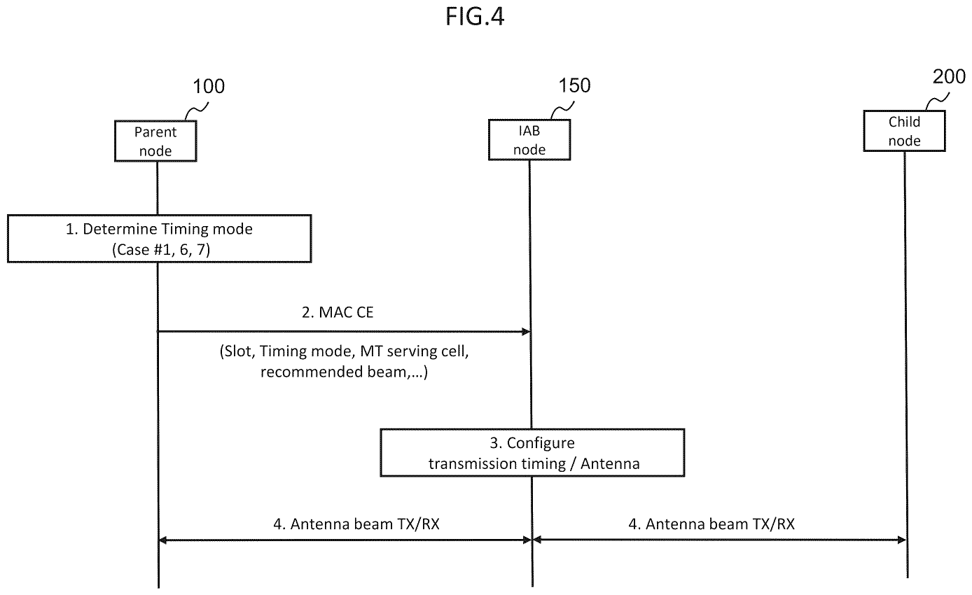

FIG. 4 shows an example of the notification sequence of the Timing mode using MAC CE. As shown in FIG. 4, the parent node (radio communication node 100) can transmit a MAC CE containing information about the Timing mode to the IAB node (radio communication node 150). The information about the Timing mode may include the slot to be applied, the Timing mode to be applied, the MT serving cell, the recommended beam, etc.

Based on the information about the Timing mode notified by the MAC CE, the IAB node may determine the DL and/or UL transmission timing and transmit/receive DL and/or UL.

The following describes an example operation related to the notification of the information about the Timing mode by the MAC CE.
(Example 1): Notification of the slot to be applied
   (Option 1): Notification of multiple slot indexes using MAC CE
   (Option 2): Notification of start slot and number of slots using MAC CE
   (Option 3): Notification of the corresponding slot using bitmap in addition to Option 2
(Example 2): Timing mode notification method
   (Option 1): Timing mode is associated with each slot to be notified in operation example 1
   (Option 2): Information about the slot in Example 1 is notified to one Timing mode
   (Option 3): Information about the slots for multiple Timing modes is collectively notified by one MAC CE in option 2
(Example 3): How to notify the MT serving cell to be applied
   (Option 1): Notify the MT cell ID together
   (Option 2): Notify the TAG ID together
(Example 4): Notify by linking with Slot index to which recommendedbeam indication is applied
   (Option 1): Notify the slots to be notified in Example 1 to linked recommended beams for each slot
   (Option 2): Notify the information about the slots in Example 1 to one recommendedbeam
   (Option 3): In Option 2, notify the slot information about multiple recommended beams together in one MAC CE

### (3.2.1) Example 1

As for the indication of the “slot list” in the MAC CE, a plurality of slot indexes may be indicated (Option 1).

In this case, the slot index may be indicated as an offset relative to the “reference slot.” The candidate range/minimum/maximum value of the offset of the slot index may be predefined by the RRC or configured accordingly.

The size of each indication may vary depending on the maximum value of the slot index (offset). The candidate value range/minimum value/maximum value of the number of slots in the MAC CE may be defined previously by the RRC or may be configured accordingly.

FIG. 5 shows a configuration example of the MAC CE according to Example 1. As shown in FIG. 5, the slot index may be indicated using 4 bits. In addition, a Timing mode indication field may be included in the MAC CE (see Example 2).

In option 2, the “slot list” may be the number of consecutive slots. The starting slot and the number of consecutive slots of the consecutive slots may be further indicated and determined as follows:
Variation: All slots (D/U/F) may be counted as the number of slots. Alternatively, only UL slots may be counted as the number of slots, or only UL or F slots may be counted as the number of slots.
(Option 2-1): The number of starting slots and/or slots is indicated by the MAC CE

The starting slot may be indicated as a offset to the “reference slot.” Alternatively, the starting slot and the number of slots may be indicated together using SLIV (Start and length indicator value).
(Option 2-2): Only the number of slots is indicated by the MAC CE.

The starting slot may be determined based on the offset relative to the “reference slot,” and the offset may be predefined or fixed, or may be configured by the RRC.

For example, the offset may be predefined as “0”.
(Option 2-3): Only the start slot is indicated by the MAC CE

The start slot may be indicated as an offset to the “reference slot.” The number of slots may be predefined or fixed, or may be configured by RRC.
(Option 2-4): Either the starting slot or the number of slots is not explicitly indicated by the MAC CE

The starting slot may be determined based on the offset relative to the “reference slot,” and the offset may be predefined or fixed, or may be configured by the RRC. In other words, the offset may be predefined as “0.”

The candidate value ranges/minimums/maximums of “starting slots” and “number of slots” may be predefined by the RRC or configured accordingly.

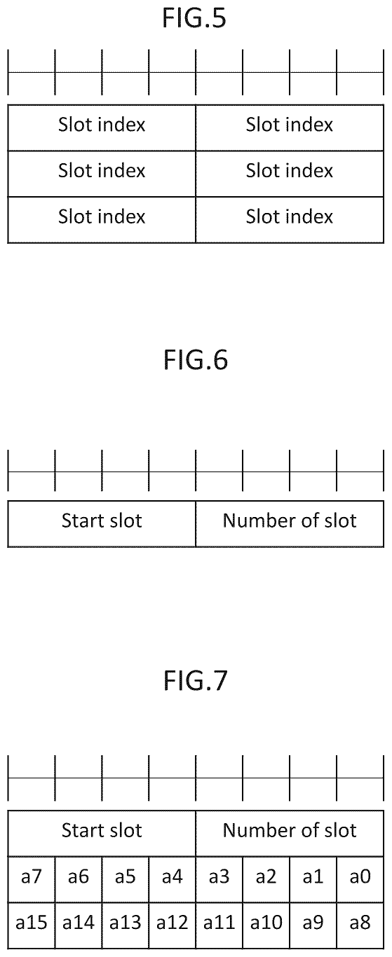

FIG. 6 shows a configuration example of a MAC CE according to Example 1 (option 2). Specifically, in the configuration example shown in FIG. 6, “start slot” and “number of slots” are indicated by four bits each.

In the case of option 3, “slot list” may be indicated by a bitmap corresponding to the consecutive slots indicated by option 2. Note that the bitmap may correspond to all slots (D/U/F). Alternatively, the bitmap may correspond to only UL slots or only UL/F slots.

Each bit may also correspond to each slot in the consecutive slots indicated by option 2. If the bit indicates “1” (or “0”), the “slot list” may be interpreted to include the corresponding slots.

FIG. 7 shows a configuration example of a MAC CE according to Example 1 (option 3). In the configuration example shown in FIG. 7, “start slot” and “number of slots” are indicated by four bits each. a0/a1/ . . . corresponds to consecutive slots (1st/2nd/ . . . ).

In this operation example, the term “reference slot” may be interpreted as any of the following.
(Option 1): The slot for receiving MAC CE
(Option 2): The slot after the X slot(s) after the slot for receiving MAC CE

“X” may be predefined or fixed, or may be configured by RRC.
(Option 3): The slot after the X slot(s) from which the ACK of the MAC CE was sent

The “X” may be predefined or fixed, or may be configured by the RRC.
(Option 4): The first slot (slot #0) of the SEN (System Frame Number) that received the MAC CE.
(Option 5) The first slot (slot #0) of the SFN, where the SFN index is indicated by the MAC CE.
(Option 6) The first slot to receive the MAC CE repeatedly.

The repetition period may be predefined or configured accordingly.

### (3.2.2) Example 2

The indication of “Timing mode (Case)” in the MAC CE may be in any of the following ways:
Case 190 1, Case #6 or Case #7
Part of Case #1, Case #6 or Case #7 based on function and/or configuration of IAB node

For example, if only Case #1 and Case #6 are supported by function and/or configuration of IAB node, only Case #1 and Case #6 may be indicated as “Timing mode (Case).”

Further, in this case, the following options may be applied:
(Option 1): One MAC CE indicates one “slot list” of operation example 1 and a “Timing mode (Case)” for each slot in the “slot list”

The number of fields in the “Timing mode (Case)” may depend on the number of slots.
(Option 2): One MAC CE indicates one “slot list” of operation example 1 and a common “Timing mode (Case)” for all slots in the “slot list.”
(Option 3): Multiple “slot list” and a “Timing mode (Case)” for each “slot list” are indicated by one MAC CE. The indication of each “slot list” may be in accordance with Example 1.

The number of “slot list” and “Timing mode (Case)” or the maximum number of “slot list” and “Timing mode (Case)” by the MAC CE may be predefined by the RRC or configured accordingly. The indication of “Timing mode (Case)” may be indicated only for UL slots or UL/F slots.

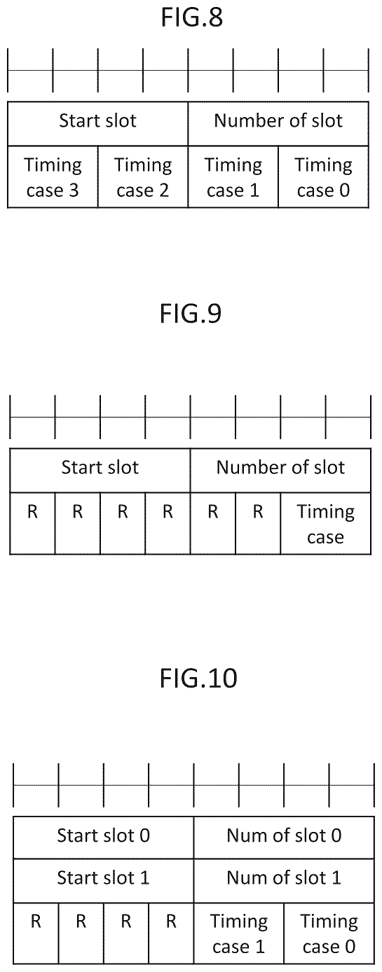

FIG. 8 shows a configuration example (part 1) of a MAC CE according to Example 2 (Option 1). In the configuration example of FIG. 8, “start slot” and “number of slots” are indicated by four bits each. Timing case 0/Timing case 1/ . . . (Timing mode (Case)) corresponds to Slot index (1st/2nd/ . . . ).

FIG. 9 shows a configuration example (part 1) of a MAC CE according to operation example 2 (option 2). In the configuration example shown in FIG. 9, “start slot” and “number of slots” are indicated by 4 bits each. Timing mode (Case) is applied to all slots. Note that “R” is a reserved bit.

FIG. 10 shows a configuration example (part 1) of a MAC CE according to Example 2 (option 3). The configuration example of FIG. 10 includes two slot lists in which the “start slot” and the “number of slots” are indicated by 4 bits each.

The timing case 0 may correspond to the first slot list (“0”), and the timing case 1 may correspond to the second slot list (“1”).

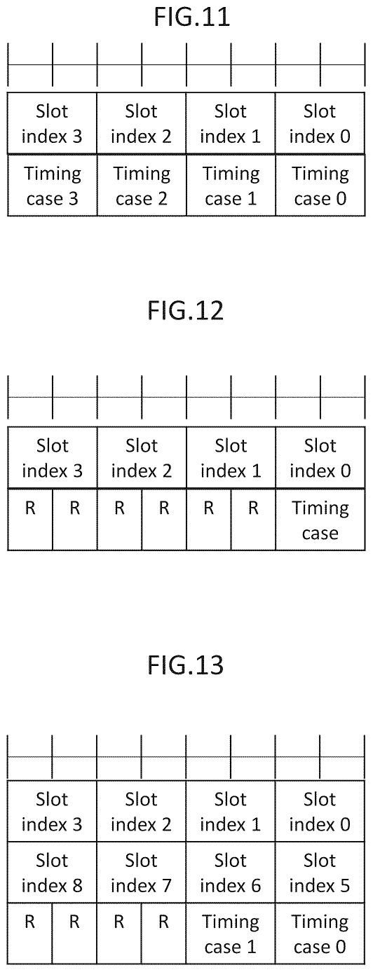

FIG. 11 shows a configuration example (part 2) of the MAC CE according to Example 2 (option 1). In the configuration example shown in FIG. 11, the timing case 0/1/2/3 corresponds to the slot index 0/1/2/3, respectively.

FIG. 12 shows a configuration example (part 2) of the MAC CE according to Example 2 (option 2). In the configuration example shown in FIG. 12, the timing case corresponds to all slot indices 0/1/2/3.

FIG. 13 shows a configuration example (part 2) of the MAC CE according to Example 2 (option 3). In the configuration example shown in FIG. 13, the timing case 0 corresponds to the first slot list (Slot index 0/1/2/3), and the timing case 1 corresponds to the second slot list (Slot index 5/6/7/8).

### (3.2.3) Operation Example 3

In addition to Example 1 and Example 2, information of the MT serving cell to which the Timing mode is applied may be notified. Specifically, any of the following options may be applied.
(Option 1): MAC CE indicates the cell ID of the MT serving cell
(Option 1-1): One MAC CE contains the cell ID of one MT serving cell and the “slot list” and “Timing mode (Case)” of one MT serving cell
(Option 1-2): One MAC CE contains the cell IDs of multiple MT serving cells and one MAC CE contains the “slot list” and “Timing mode (Case)” of each MT cell
(Option 1-3): One MAC CE contains the cell IDs of multiple MT serving cells, and one MAC CE contains the “slot list” and “Timing mode (Case)” common to multiple MT serving cells
(Option 2): MAC CE indicates the TAG ID (or other MT serving cell group ID)
(Option 2-1): One MAC CE contains one TAG ID (or other MT serving cell group ID) and one TAG (or MT cell group) “slot list” and “Timing mode (Case)”
(Option 2-2): If a MAC CE contains more than one TAG ID (or other MT serving cell group ID), one MAC CE contains “slot list” and “Timing mode (Case)” for each TAG ID (or MT cell group)
(Option 2-3): If a MAC CE contains more than one TAG ID (or MT cell group), one MAC CE contains common “slot list” and “Timing mode (Case)” to multiple TAG IDs (or MT cell groups)

### (3.2.4) Example 4

The indication of “recommendedbeam” in the MAC CE may be in any of the following ways:
(Option 1): One MAC CE contains a “slot list”, a set of recommended beams corresponding to each slot
(Option 2): One MAC CE contains a “slot list”, a common set of recommended beams for all slots
(Option 3): Multiple “slot lists”, a set of recommended beams for each “slot list”

The MAC CE candidate value range and/or the minimum/maximum number of slots/number of slot lists may be previously defined by the RRC or configured accordingly.

The candidate value range/minimum/maximum number of slots, MTs, MT BWPs, MT serving cells, {MT Serving Cell, DU Cell} pairs, multiplexing cases, number of MT UL beams, number of MT DL beams may also be previously defined by the RRC or configured accordingly.

Note that the “slot list” may be interpreted in the Same manner as in Example 1. The recommended beam itself may be notified using the MAC CE as described above.

### (3.2.5) Others

With respect to the Examples 1 through 3 described above, the following capabilities of the IAB node may be defined.
Whether UL transmission timing in Case #1, Case #6 or Case #7 is supported/required
Whether dynamic switching of UL transmission timing in Case #1, Case #6 or Case #7 is supported
In addition, the following capability of the IAB node may be defined with respect to the above-described operation example 4.
Whether the recommendedbeam indication is supported
Whether the recommendedbeam indication associated with the slot index is supported

### (4) Operational Effects

According to the above-described embodiment, the following effects can be obtained. Specifically, an upper node, such as a parent node (IAB donor), can notify a lower node, such as an IAB node, of a MAC CE containing information about a slot to which a determined transmission timing (Timing mode) is applied.

Therefore, the upper node can appropriately notify a plurality of Timing modes by using the MAC CE.

### (5) Other Embodiments

Although the contents of the present invention have been described by way of the embodiments, it is obvious to those skilled in the art that the present invention is not limited to what is written here and that various modifications and improvements thereof are possible.

For example, although the names of the parent node, the IAB node, and the child node were used in the above embodiment, the names may be different insofar as the configuration of the radio communication node in which the radio backhaul between the radio communication nodes such as gNB and the radio access to the terminal are integrated is adopted. For example, it may be simply called the first node, the second node, etc., or it may be called an upper node, a lower node, a relay node, an intermediate node, etc.

Furthermore, the radio communication node may be referred to simply as a communication device or communication node, or may be read as a radio base station.

In the Foregoing Description, Configure, Activate, update, indicate, enable, specify, and select may be read as each other. Similarly, link, associate, correspond, and map may be read as each other, and allocate, assign, monitor, and map may be read as each other.

In addition, specific, dedicated, UE-specific, and UE-specific may be read as each other. Similarly, common, shared, group-common, UE-common, and UE-shared may be read as each other.

In the present disclosure, terms such as “precoding,” “precoder,” “weight,” “quasi-co-location (QCL),” “Transmission Configuration Indication state (TCI state)” “spatial relation,” “spatial domain filter,” “transmit power,” “phase rotation,” “antenna port,” “antenna port group,” “layer,” “number of layers,” “rank,” “resource,” “resource set,” “resource group,” “beam,” “beam width,” “beam angle,” “antenna,” “antenna element,” “panel,” and the like may be used interchangeably.

The block configuration diagrams (FIGS. 2 and 3) used for the description of the above-described embodiment show blocks of functional units. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or radio) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (configuration part) that functions transmission is called a transmission unit (transmitting unit) or a transmitter.

As described above, the method of realization of both is not particularly limited.

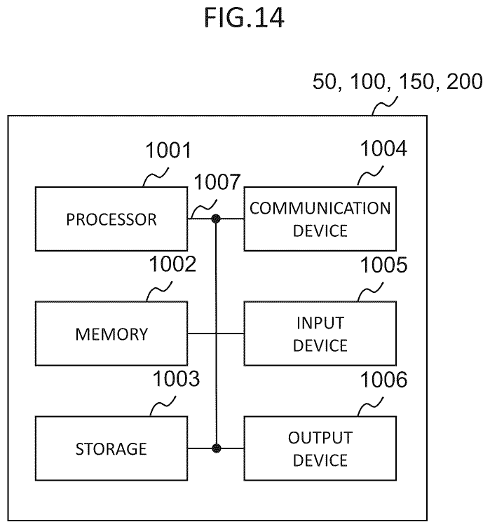

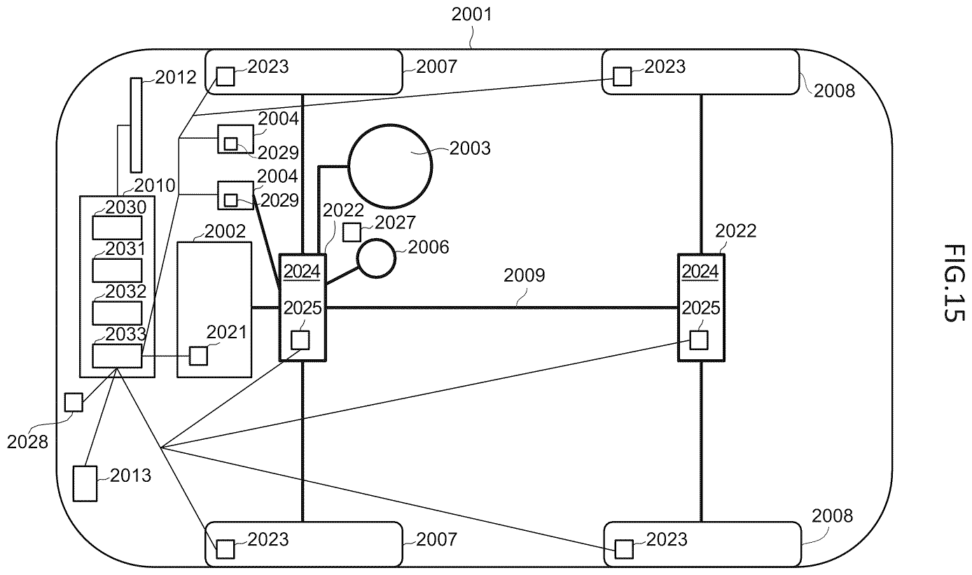

Furthermore, the radio communication node 50, the radio communication node 100, the radio communication node 150 and the UE 200 (the device) may function as a computer for processing the radio communication method of the present disclosure. FIG. 14 is a diagram showing an example of the hardware configuration of the device. As shown in FIG. 14, the device may be configured as a computer device including a processor 1001, a memory 1002, a storage 1003, a communication device 1004, an input device 1005, an output device 1006 and a bus 1007.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIGS. 2 and 3) is implemented by any hardware element of the computer device or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

Processor 1001, for example, operates an operating system to control the entire computer. Processor 1001 may be configured with a central processing unit (CPU) including an interface to peripheral devices, a controller, a computing device, a register, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), or the like. The memory 1002 ay store a program (program code), a software module, or the like capable of executing a method according to an embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device, such as the processor 1001 and the memory 1002, is connected by a bus 1007 for communicating information. The bus 1007 may be configured using a single bus or a different bus for each device.

In addition, the device may comprise hardware such as a microprocessor, a digital signal processor (DSP), an application specific integrated circuit (ASIC), a programmable logic device (PLD), a field programmable gate array (FPGA), or the like, which may provide some or all of each functional block. For example, the processor 1001 may be implemented by using at least one of these hardware.

Information notification is not limited to the aspects/embodiments described in the present disclosure and may be performed using other methods. For example, information notification may be performed by physical layer signaling (e.g., Downlink Control Information (DCI), Uplink Control Information (UCI), higher layer signaling (e.g., RRC signaling, Medium Access Control (MAC) signaling, Notification Information (Master Information Block (MIB), System Information Block (SIB)), other signals, or a combination thereof. RRC signaling may also be referred to as RRC messages, e.g., RRC Connection Setup messages, RRC Connection Reconfiguration messages, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark) ), IEEE 802.16 (WiMAX (Registered Trademark) ), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, etc. of the embodiments/embodiments described in the present disclosure may be rearranged as long as there is no conflict. For example, the method described in the present disclosure presents the elements of the various steps using an exemplary sequence and is not limited to the particular sequence presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each of the embodiments/embodiments described in the present disclosure may be used alone, in combination, or alternatively with execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channels and symbols may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS) ,” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas.

In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS),” “user terminal,” “user equipment (User Equipment: UE),” “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile may be a vehicle (For example, cars, planes, etc.), an unmanned mobile (For example, drones, self-driving cars,), or a robot (manned or unmanned). At least one of a base station and a mobile station can be a device that does not necessarily move during the communication operation. For example, at least one of a base station and a mobile station may be an Internet of Things (IOT) device such as a sensor.

The base station in the present disclosure may be read as a mobile station (user terminal, hereinafter the s same). For example, each aspect/embodiment of the present disclosure may be applied to a configuration in which communication between a base station and a mobile station is replaced by communication between a plurality of mobile stations (For example, it may be called device-to-device (D2D), vehicle-to-everything (V2X), etc. ). In this case, the mobile station may have the function of the base station. Further, words such as “up” and “down” may be replaced with words corresponding to communication between terminals (For example, “side”). For example, terms an uplink channel, a downlink channel, or the like may be read as a side channel.

Similarly, the Mobile Station in the Present

disclosure may be replaced with a base s station. In this case, the base station may have the function of the mobile station.

A radio frame may be composed of one or more frames in the time domain.

Each frame or frames in the time domain may be referred to as a subframe. A subframe may be further configured by one or more slots in the time do. main.

The subframe may have a fixed time length (e.g., 1 ms) that does not depend on the numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in units of time greater than the minislot may be referred to as PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the subframe and the TTI may be a subframe (1 ms) in the existing LTE, a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. The number of slots (number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain.

The number of subcarriers included in RB may be, for example, twelve, and the same regardless of the topology.

The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (SubCarrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB relative to the common reference point of the carrier. PRB may be defined in BWP and numbered within that BWP.

BWP may include UL BWP (UL BWP) and DL BWP (DL BWP). One or a plurality of BWPs may be configured in one carrier for the UE.

At least one of the configured BWPs may be active, and the UE may not expect to transmit and receive certain signals/channels outside the active BWP. Note that “cell,” “carrier,” and the like in this disclosure may be read as “BWP.”

The above-described structures such as a radio frame, subframe, slot, minislot, and symbol are merely examples.

For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected,” “coupled,” or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access.” In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to an element using a designation such as “first,” “second,” and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include,” “including,” and variants thereof are intended to be inclusive in a manner similar to the term “comprising.” Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. In other words, “judgment” and “decision” may include regarding some action as “judgment” and “decision.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.”Terms such as “leave,” “coupled,” or the like may also be interpreted in the same manner as “different.”

FIG. 15 shows a configuration example of a vehicle 2001. As shown in FIG. 15, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021˜2029, an information service unit 2012, and a communication module 2013.

The drive unit 2002 is composed of, for example, an engine, a motor, and an engine-motor hybrid.

The steering unit 2003 includes at least a steering wheel and is configured to steer at least one of the front and rear wheels based on the operation of the steering wheel operated by the user.

The electronic control unit 2010 consists of a microprocessor 2031, a memory (ROM, RAM) 2032 and communication ports (10 ports) 2033. The electronic control unit 2010 receives signals from various sensors 2021˜2027 provided in the vehicle. The electronic control unit 2010 may be referred to as an ECU (Electronic Control Unit).

The signals from the various sensors 2021˜2028 include a current signal from a current sensor 2021 for sensing the current of a motor, a speed signal of a front wheel and a rear wheel acquired by an rpm sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal depressing amount signal acquired by an accelerator pedal sensor 2029, a brake pedal depressing amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like.

The information service unit 2012 comprises various devices such as a car navigation system, an audio system, a speaker, a television, and a radio for providing various information such as driving information, traffic information, and entertainment information, and one or more ECUs for controlling these devices.

The information service unit 2012 provides various multimedia information and multimedia services to the occupants of the vehicle 2001 by utilizing information acquired from an external device via the communication module 2013 or the like.

A driver assistance system unit 2030 consists of various devices, such as millimeter-wave radar, LiDAR (Light Detection and Ranging), camera, positioning locator (e.g. GNSS), map information (e.g. high-definition (HD) maps, self-driving car (AV) maps, etc.), gyro system (e.g. IMU (Inertial Measurement Unit), INS (Inertial Navigation System), etc.), AI (Artificial Intelligence) chip, AI processor, which are used to provide functions to prevent accidents or reduce the driver's driving load, and one or more ECUs that control these devices. The driver assistance system unit 2030 also transmits and receives various information via the communication module 2013 to realize a driver assistance function or an automatic driving function.

The communication module 2013 can communicate with the microprocessor 2031 and components of the vehicle 2001 via a communication port. For example, the communication module 2013 transmits and receives data via the communication port 2033 to and from the microprocessor 2031, the memory (ROM, RAM) 2032, and the sensors 2021˜2028 in the drive unit 2002, the steering unit 2003, the accelerator pedal 2004, the brake pedal 2005, the shift lever 2006, the left and right front wheels 2007, the left and right rear wheels 2008, the axle 2009, and the electronic control unit 2010 in the vehicle 2001.

The communication module 2013 is a communication device that can be controlled by the microprocessor 2031 of the electronic control unit 2010 and can communicate with external devices. For example, it transmits and receives various information to and from external devices via radio communication. The communication module 2013 may be either inside or outside the electronic control unit 2010. The external device may be, for example, a base station, a mobile station, etc.

The communication module 2013 transmits a current signal from a current sensor input to the electronic control unit 2010 to an external device via radio communication. The communication module 2013 also transmits, via radio communication, to an external device the speed signals of the front and rear wheels acquired by the rpm sensor 2022, the air pressure signals of the front and rear wheels acquired by the air pressure sensor 2023, the vehicle speed signals acquired by the vehicle speed sensor 2024, the acceleration signals acquired by the acceleration sensor 2025, the accelerator pedal depressing amount signals acquired by the accelerator pedal sensor 2029, the brake pedal depressing amount signals acquired by the brake pedal sensor 2026, the shift lever operation signals acquired by the shift lever sensor 2027, and the detection signals acquired by the object detection sensor 2028 for detecting obstacles, vehicles, pedestrians, etc., which are inputted to the electronic control unit 2010.

The communication module 2013 receives various kinds of information (traffic information, signal information, Inter-vehicular distance information, etc.) transmitted from an external device and displays them to the information service unit 2012 provided in the vehicle. The communication module 2013 also stores various information received from external devices in the memory 2032 available by the microprocessor 2031. Based on the information stored in the memory 2032, the microprocessor 2031 may the control drive unit 2002, the steering unit 2003, the accelerator pedal 2004, the brake pedal 2005, the shift lever 2006, the left and right front wheels 2007, the left and right rear wheels 2008, the axle 2009, the sensors 2021˜2028, etc. provided in the vehicle 2001.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system
20 NG-RAN
50 radio communication node
51 radio communication unit
53 NW IF unit
55 lower node connection unit
57 control unit
100 radio communication node
110 radio communication unit
150 radio communication node
170 upper node connection unit
180 lower node connection unit
190 control unit
200 UE
1001 processor
1002 memory
1003 storage
1004 communication device
1005 input device
1006 output device
1007 bus
2001 vehicle
2002 drive unit
2003 steering unit
2004 accelerator pedal
2005 brake pedal
2006 shift lever
2007 left and right front wheels
2008 left and right rear wheels
2009 axle
2010 electronic control unit
2012 information service unit
2013 communication module
2021 current sensor
2022 rpm sensor
2023 air pressure sensor
2024 speed sensor
2025 acceleration sensor
2026 brake pedal sensor
2027 shift lever sensor
2028 object detection sensor
2029 accelerator pedal sensor
2030 driver assistance system unit
2031 microprocessor
2032 memory (ROM, RAM)
2033 communication port

1. A radio communication node comprising:
a control unit that determines a transmission timing of at least one of a downlink and an uplink; and
a transmission unit that transmits a control element of a medium access control layer including information on a slot to which the transmission timing determined is applied to the lower node.

2. The radio communication node of claim 1, wherein the control element includes the transmission timing associated with the slot.

3. The radio communication node according to claim 1, wherein the control element includes information on a cell formed by the radio communication node.

4. The radio communication node according to claim 1, wherein the control element includes information on a recommended antenna beam recommended for use.

5. A radio communication method comprising the steps of:
determining a transmission timing of at least one of a downlink and an uplink; and
transmitting a control element of a medium access control layer including information on a slot to which the transmission timing determined is applied to the lower node.
